(19) United States
(12) Patent Application Publication
(10) Pub. No.: US 2014/0088802 A1
(43) Pub. Date: Mar. 27, 2014

(54) RAILWAY TRAIN CONTROL SYSTEM HAVING MULTIPURPOSE DISPLAY

(71) Applicant: SIEMENS INDUSTRY, INC., Alpharetta, GA (US)

(72) Inventors: Volker Knollmann, Jersey City, NJ (US); Eckart Thies, Maple Grove, MN (US); Jan Schmidt, Astoria, NY (US)

(73) Assignee: SIEMENS INDUSTRY, INC., Alpharetta, GA (US)

(21) Appl. No.: 13/628,229

(22) Filed: Sep. 27, 2012

(51) Int. Cl. B61L 27/00; G05D 1/02

(52) U.S. Cl. 701/20; 701/19; 246/167 R

(57) ABSTRACT

A railway train control system having a multi-purpose display is disclosed. The railway train control system includes a human-machine interface having a first display and a second, display. The first display provides a train control interface that enables a first operator, such as an engineer, to control one or more functions of the train. The second display is a multipurpose display that can switch between a standard mode and an application mode. The second display displays a read-only display of the train control interface in the standard mode and displays applications to enable a second operator, such as a conductor, to complete various tasks in the application mode.

### BACKGROUND OF THE DISCLOSURE

1. Field of the Invention

The invention relates to a railway train control system having a multipurpose display. More particularly, the present invention relates to a display that can switch between a standard mode and an application mode in a railway train control system having a vital on board unit (OBU) with low hazard rates. As used herein, the term “train” is a locomotive alone, locomotive with cars, or an integrated locomotive/car vehicle, (e.g., light rail or subway).

2. Description of the Prior Art

Rail lines establish maximum local operating speeds along the track right of way, dictated among other things by track conditions, train line congestion and distances ahead of trains that are needed for braking and acceleration to different speeds. Railway operators also establish points of interest along the railway tracks that suggest minimal or optimal speeds for local track conditions, efficient energy usage and travel scheduling. Other critical points exist along the railway tracks that mandate maximum speeds or need to stop completely. Points of interest may be fixed and marked by trackside signals (e.g., visual signage, sensors, and/or wireless transmitters). Points of interest may also be varied depending upon operating conditions, and communicated to the train operators via reconfigurable electronic signage or wireless transmission.

Trains are typically operated by two operators, an engineer and a conductor. Human interface tools are typically provided to both operators on separate displays. In particular, a first operator (e.g., the engineer) interacts with the interface on one display to control various locomotive functions, and a second operator (e.g., the conductor) is shown the same interface in a “read only” format in another display to monitor the actions of the first operator.

Electronic onboard and/or remote oversight of train operation is becoming more prevalent in order to optimize system-wide operation based on changing conditions and reduce likelihood of human error caused incidents. So-called Positive Train Control (PTC) Systems provide for onboard and remote monitored automatic train operation supervision and control by an electronic Onboard Unit (OBU). The OBU is coupled to or incorporated within the locomotive control system, sometimes referred to as the train management system (TMS). The OBU automatically slows or stops a train that exceeds local speed restrictions or fails to obey a stop signal. The most aggressive OBU control operation is complete stopping of a train that exceeds maximum local speed limits or fails to stop at a designated stopping point.

Railway trains are equipped with critical or vital systems that are required to have high dependability. Railway vital application systems (“vital systems”) include by way of non-limiting example train management systems, onboard units for automatic intervention if a train exceeds safeguarded speed limits, train speed and position determination equipment, and brake and throttle controls. Railway operators and governmental regulators often require a hazard rate of no more than 10⁻⁹ per operational hour for a vital function (i.e., about one failure incident per 114.000 years of operation). Critical or vital systems are typically operated with electronic control systems. Over time those systems are gravitating to processor or controller operated digital electronic systems that communicate with each other over one or more communications data buses.

In order to meet railway failure-free objectives, control system hardware is often of proprietary dedicated design with documented testing and validation. Digital electronic controller operating systems and application software are also validated. Electronic data communications utilize validated security codes for data integrity checks, such as hash codes or cryptographic attachments, in order to assure data integrity upon transmission between the systems.

In cases in which the OBU is a vital OBU that meets the required low hazard rate, there is little or no need for the conductor to monitor the engineer. In particular, since the OBU automatically slows or stops a train that exceeds maximum local speed limits or fails to stop at a designated stopping point, and the OBU is a vital system that meets the low hazard rate criteria, the monitoring of the engineer by the conductor becomes redundant.

### SUMMARY OF THE INVENTION

Accordingly, an object of the present invention is to provide a multi-purpose interface that allows applications to increase the productivity of the conductor.

It is also an object of the present invention to reduce hardware costs by integrating the multi-purpose conductor interface with a railway train control system and re-using the existing communication infrastructure.

Embodiments of the present invention provide a multi-purpose conductor display that is capable of switching between a standard conductor mode and an application mode. In the standard conductor mode, the conductor display displays a read-only display of a train control interface displayed on a display of the engineer. In the application mode, the conductor display provides an interactive interface that allows the conductor to interact with various applications to fulfill various tasks.

In one embodiment, a railway train control system includes a human-machine interface and a vital on-board unit (OBU). The human machine interface includes a first display providing a train control interface for a first operator to control a speed of the train, and a second display configured, to display a read-only display of the train control interface in a standard mode and configured to display one or more applications for a second train operator in an application mode. The vital OBU includes a vital controller configured to monitor the speed, of the train and to intervene in controlling the speed of the train if the speed of the train exceeds local limits, and configured to control the train control interface, and a non-vital processor configured, to control the one or more applications displayed on the second display when the second display is in the application mode.

In another embodiment, a human-machine interface of a train control system includes a multi-purpose display switchable between a standard mode and an application mode and an actuator. The multi-purpose display is configured to display a read-only display of train control interface displayed on another display of the train control system in the standard mode and configured to display one or more applications for in the application mode. The actuator switches the multi-purpose conductor display between the standard mode and the conductor mode.

In another embodiment, an on board, unit (OBU) of a railway train control includes a vital controller and a non-vital processor. The vital controller is configured to monitor the speed of the train, configured to intervene in controlling the speed of the train if the speed of the train exceeds local limits, configured to control a train control interface displayed on a first display, and configured to control a second display to display a read-only display of the train control interface when the conductor display is in a standard mode. The non-vital processor is configured to control one or more applications to be displayed on the second display when the second display is in an application mode.

In another embodiment, a method of controlling a multi-purpose display in a railway train control system includes displaying, on the multi-purpose display, a read-only display of a train control interface displayed on another display in the train control system in a standard mode of the multi-purpose display, switching the multi-purpose display from the standard mode to an application mode, and displaying one or more applications for user interaction on the multi-purpose display in the application mode.

The objects and features of the present invention may be applied jointly or severally in any combination or sub-combination by those skilled in the art.

### BRIEF DESCRIPTION OF THE DRAWINGS

The teachings of the present invention can be readily understood by considering the following detailed description in conjunction with the accompanying drawings, in which:

FIG. 1 illustrates a general schematic of a train control system according to an embodiment of the present invention;

FIG. 2 is a general schematic of a train control system computer or controller;

FIG. 3 illustrates a vital on board unit (OBU) control structure according to an embodiment of the present invention; and

FIG. 4 illustrates a method of controlling a multi-purpose display according to an embodiment of the present invention.

To facilitate understanding, identical reference numerals have been used, where possible, to designate identical elements that are common to the figures.

### DETAILED DESCRIPTION

After considering the following description, those skilled in the art will clearly realize that the teachings of the present invention can be readily utilized in railway train control systems including a user interface having a multipurpose display. The interface of the present invention provides a display that is enhanced to allow a switch-over between a standard train control mode and an application mode. In the standard mode, the multipurpose display displays a read-only display of a train control human machine interface (HMI) displayed on another display in the train control system, and in the application mode, a user, such as the conductor, can interact with various applications displayed on the multipurpose display to fulfill various tasks. The railway train control system of the present invention also includes an on board unit (OBU) having a set of vital processors and a non-vital processor. In embodiments of the present invention, the multipurpose display may be a conductor display and the applications displayed on the conductor display in the application mode are controlled, by the non-vital processor of the OBU. These embodiments of the present invention can be implemented without compromising safety since the OBU is a vital system that is substantially hazard free. In non-vital train control systems, the conductor is required to monitor the engineer, and thus cannot switch the conductor display away from the train control HMI.

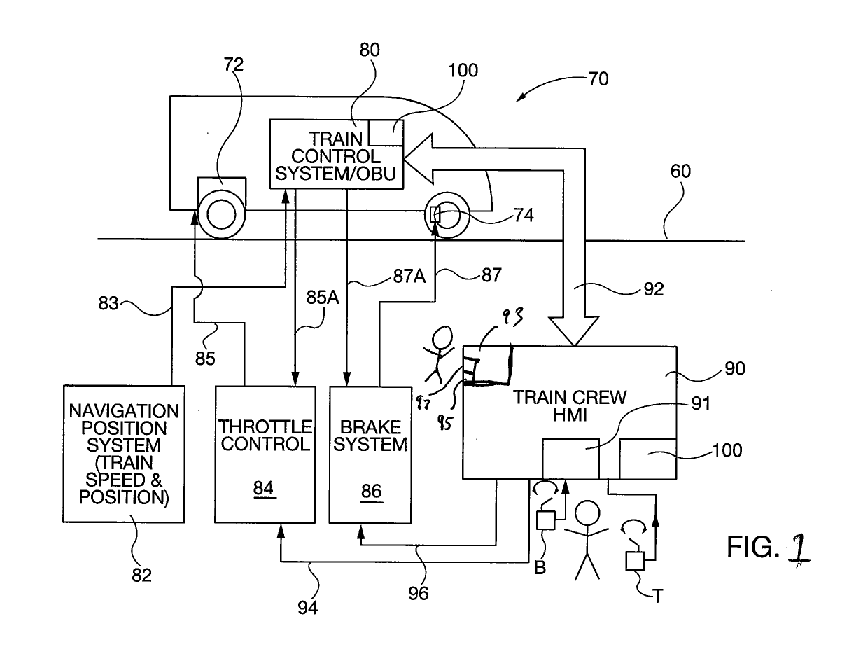

FIG. 1 shows generally a railway system with fixed tracks 60 and one or more trains 70. Train 70 generally has subsystems, including drive system 72 that provides driving force to one or more wheel carriages, and brakes 74 for altering train speed. The train control system, often referred to as the “train management system” (TMS) 80 is the central control system for the locomotive or for multiple slaved, locomotives in a coupled set of railway locomotives and cars. The train control system 80 is the principal electronic control device for all other controlled train subsystems, including the onboard unit (OBU). The OBU is incorporated within the TMS 80 or is a separately coupled, device that intervenes in train speed control and braking in the event that the train operator fails to follow local track speed and stopping mandates. The train control system 80 also is coupled to the navigation position system (NPS) 82 that provides train position and speed information via communications pathway 83. Other subsystems coupled to the train control system 80 include throttle control 84 that controls the drive system 72 (e.g., more or less throttled speed) via communications pathway 85 and receives commands from the OBU 80 via communications pathway 85A. The brake system 86, via communication pathway 87, causes the brakes 74 to brake the train 70. The brake system 86 also receives commands from the OBU 80 via communications pathway 87A.

In embodiments of the present invention, the TMS/OBU 80 is a “vital” system. As used herein, the term “vital” means that the system is proven to meet a sufficiently low hazard rate so that it is substantially failure free. For example, railway operators and governmental regulators often require a hazard rate of no more than 10⁻⁹ per operational hour for a vital function (i.e., about one failure incident per 114.000 years of operation. The vital TMS/OBU 80 includes a set of vital controller that controls vital train control functions and intervention functions and ensures such vital functions are substantially failure free. The vital TMS/OBU 80 also includes a non-vital processor that can be used to control non-vital functions of the train control system.

The train 70 also has a train crew human-machine interface (HMI) 90 that has first and second electronic display screens 91 and 93 for first and second train operators, respectively. In one embodiment, the first display screen 91 is an engineer display 91 for the engineer and the second display screen 93 is conductor display 93 for the conductor. Hereinafter, the terms “engineer display” and “conductor display” are used interchangeably with “first display” and “second display”, respectively. It is to be understood that these terms are used, to illustrate the invention by way of a particular embodiment, but the present invention is not limited to the first display being an engineering display and second display being a conductor display. The HMI 90 is connected to operator actuated brake B and throttle T train speed control actuators, so that the engineer can drive the train. The HMI 90 provides a train control user interface on the engineer display 91 that can include information related to train position, train speed, local speed restrictions, and upcoming points of interest (e.g., stop signals, track switches, changes in local speed, etc.). In a possible implementation, the brake B and throttle T train speed control actuators can be controlled by the engineer using the TRAIN CONTROL user interface, for example using touch-screen technology. The HMI 90 communicates with the OBU 80 via communications data bus 92, though other known communications pathways can be substituted for the data bus when implementing other known control system architectures. The HMI 90 communicates train operator respective throttle T and brake B control commands to the respective throttle control 84 via communications pathway 94 and the brake system 86 via communications pathway 96.

According to an advantageous embodiment of the present invention, the second display 93 (e.g., conductor display) is a multi-purpose display that can switch between a standard train control mode and an application mode. In the standard mode, the conductor display 93 displays a read-only display of the train control interface displayed on the engineer display 91. This allows the conductor to monitor the engineer, for example, to ensure correct signal aspect interpretation and compliance with speed restrictions. In the application mode, the conductor display 93 displays various applications the conductor can use to fulfill various tasks. In one embodiment, the application mode can be implemented using a split screen on the conductor display 93 to allow the conductor to still view the read-only display of the train control interface on one portion of the screen while interacting with an application on another portion of the screen. In another embodiment, activation of the application mode on the conductor display 93 switches the HMI 90 into an “asymmetric” mode in which the complete screen of the conductor display 93 is used for the application, while the engineer display 91 shows the train control interface. This asymmetric mode is feasible because the OBU 80 is a vital system, which makes it unnecessary for the conductor to monitor the engineer. If the OBU 80 was not vital, and thus substantially failure free, the conductor would be required to monitor the engineer and could not switch to a display in which the train control interface was not shown.

The HMI 90 includes an actuator 95 that switches the conductor display 93 between the standard mode and the application mode. For example, the actuator 95 can be a switch or button located on an external portion of the conductor display 93 or a touch-screen control displayed on the conductor display 93. The HMI 90 also includes conductor controls 97 that allow the conductor to interact with applications displayed on the conductor display 93 when the conductor display 93 is in the application mode. In an embodiment of the present invention, the conductor controls 97 (other than the actuator 95) are only activated when the conductor display 93 is in the application mode, since the standard mode provides a read-only display. The conductor controls 97 can be implemented using touch-screen technology. The particular touch-screen controls and options can be application-specific depending on which application is currently displayed on the conductor display 93.

In an advantageous embodiment of the present invention, the train control interface displayed on the first display 91 (e.g., engineer display) and displayed as a read-only display on the second display 93 (e.g., conductor display) when operating in the standard mode is controlled by the vital controller of the TMS/OBU 80, while the applications displayed on the second display 93 (e.g., conductor display) in the application mode controlled by the non-vital, processor of the TMS/OBU 80.

Each of the OBU train control system 80 and the HMI 90 have internal computer/controller platforms 100 of known design that communicate with each other via data bus 92, however the number of computer controllers, their location and their distributed functions may be altered as a matter of design choice. In this exemplary embodiment, general control of train 70 subsystems is performed by OBU 80 and the controller platform 100 therein and the HMI functions are performed by HMI 90 and the controller platform 100 therein.

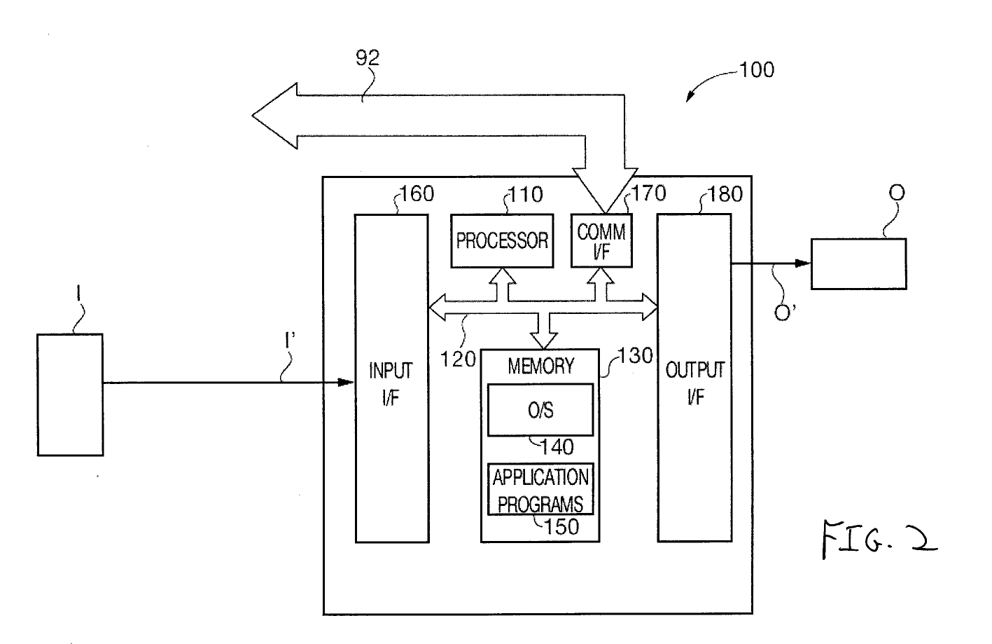

FIG. 2 illustrates a high-level block diagram of a generalized control platform 100. Referring to FIG. 2, controller platform 100 includes at least one processor 110 and a controller bus 120 in communication therewith. Processor 110 is coupled to one or more internal or external memory devices 130 that include therein operating system 140 and application program 150 software module instruction sets that are accessed and executed by the processor, and cause its respective control device (e.g., OBU 80 or HMI 90) to perform control operations over their respective associated subsystems.

While reference to an exemplary controller platform 100 architecture and implementation by software modules executed, by the processor 110, it is also to be understood that the present invention may be implemented in various forms of hardware, software, firmware, special purpose processors, or a combination thereof. Various aspects of the present invention may be implemented in software as a program tangibly embodied on a program storage device. The program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform 100 also includes an operating system and microinstruction code. The various processes and functions described herein may be either part of the microinstruction code or part of the program (or combination thereof) which is executed via the operating system. In addition, various other peripheral devices may be connected to the computer/controller platform 100.

It is to be understood that, because some of the constituent system components and method steps depicted in the accompanying figures are preferably implemented in software, the actual connections between the system components (or the process steps) may differ depending upon the manner in which the present invention is programmed. Specifically, any of the computer platforms or devices may be interconnected using any existing or later-discovered networking technology and may also all be c connected through a larger network system, such as a corporate network, metropolitan network or a global network, such as the Internet.

Computer/controller platform 100 receives input communications from one or more input devices I via respective communications pathways I′ through input interface 160, that in turn can distribute the input information via the controller bus 120. The controller platform 100 also has a communications interface 170 for communication with other controllers on a shared external data bus, such as the data bus 92. Output interface 180 facilitates communication with one or more output devices O via associated communications pathways O′.

In the present invention the computer/controller platform 100 in train control system 80 is associated with input devices I/associated input communications pathways I′ that include the navigation position system (NPS) 82/83. Output devices O/associated output communications pathways O′ that are associated with that computer/controller platform 100 include override communications to the throttle control 84/85A and brake system 86/87A.

Similarly in the present invention, the computer/controller platform 100 in HMI system 90 is associated with input devices I/associated input communications pathways I′ that include the human operated throttle T and brake B speed control actuators and any touch screen input functions of display 91. Output devices O/associated output communications pathways O′ that are associated with the HMI System 90 computer/controller platform 100 include the throttle control system 84/94 and the brake control system 86/96.

The OBU subsystem 80 monitors track position and speed of the train 70 to assure that the latter is operated within local permissible speed limits, including braking distances needed to stop the train ahead of critical stopping points, such as switches or track crossings. If the engineer does not operate the train 70 within permissible speeds the OBU intervenes once the train exceeds a local intervention speed limit. If the engineer fails to stop the train 70 by a critical braking point the OBU will also intervene to stop the train. As described above, in order for the conductor display 93 to operate in an application mode in which the read-only train control interface is not shown on the conductor display 93, the OBU 80 must be a vital OBU, which operates at sufficiently low hazard rate so that it is substantially failure free. In one embodiment, the OBU 80 may control the train using positive train control (PTC). In this case, a PTC interface is displayed on the first display 91 (e.g., engineer display) and a read-only display of the PTC interface is displayed on the second display 93 (e.g., conductor display) when the second display 93 is in the standard mode.

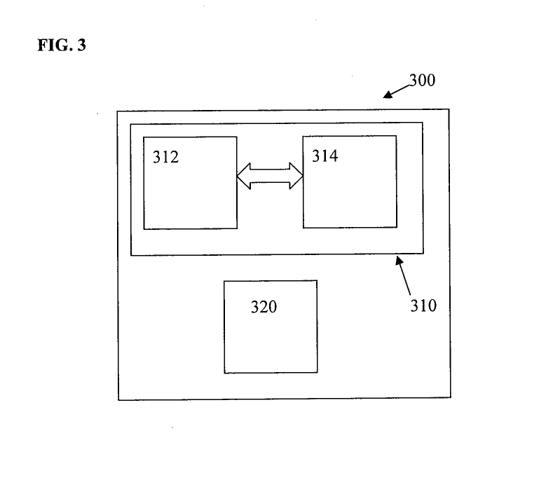

FIG. 3 illustrates a vital OBU control structure 300 according to an embodiment of the present invention. As illustrated, in FIG. 3, the control structure 300 of a vital OBU includes a vital controller 310 and a non-vital processor 320. The vital controller 310 includes a set of vital processors 312 and 314. In an exemplary embodiment, the vital processors 312 and 314 ensure fail-proof operation by each performing all processing operations for vital functions while comparing output data resulting from each processor 312 and 314 for each operation to ensure that both processors 312 and 314 agree. If, at any time, the output from the vital processors 312 and 314 is inconsistent, or if either processor 312 or 314 fails, the vital controller 310 of the OBU 80 automatically controls the brake system 87 to stop the train. This technical principle is referred to as 2-out-of-2 (2oo2). Alternatively, the vital OBU may be implemented using other configurations such as 2oo3 or 2×2oo2, which offer redundancy and can compensate for one or more processor failures. The vital controller 310 controls vital train control and intervention functions, such as monitoring train location, train speed and breaking distance, emergency brake triggering, and checking data integrity when using data through non-vital storage (e.g., using validated security codes, such as hash codes or cryptographic attachments).

The non-vital processor 320 is used to control non-vital train control functions. For example, the non-vital processor 320 can monitor signals from sensors that monitor various non-vital conditions, such as brake pressure and a position of an acceleration lever, low level input/output signals within the locomotive, and implement diagnostic functions such as error logs.

In one embodiment, the vital controller 310 and

the non-vital processor 320 can be implemented using separate computers, each having a respective control platform 100, as illustrated in FIG. 2. In this case, the vital controller 310 can be implemented as a single computer that includes both vital processors 312 and 314, or each vital processor 312 and 314 can be implemented, using separate computers. In another embodiment, the vital processors 312 and 314 of the vital controller 310 and the non-vital processor 320 can all be included within a single computer.

The vital controller 310 of the OBU controls the train control interface that is displayed on the engineer display 91 and is presented as a read-only display on the conductor display 93 when operating in the standard mode. The non-vital processor 312 of the OBU controls the applications displayed on the conductor display 93 when operating in the application mode.

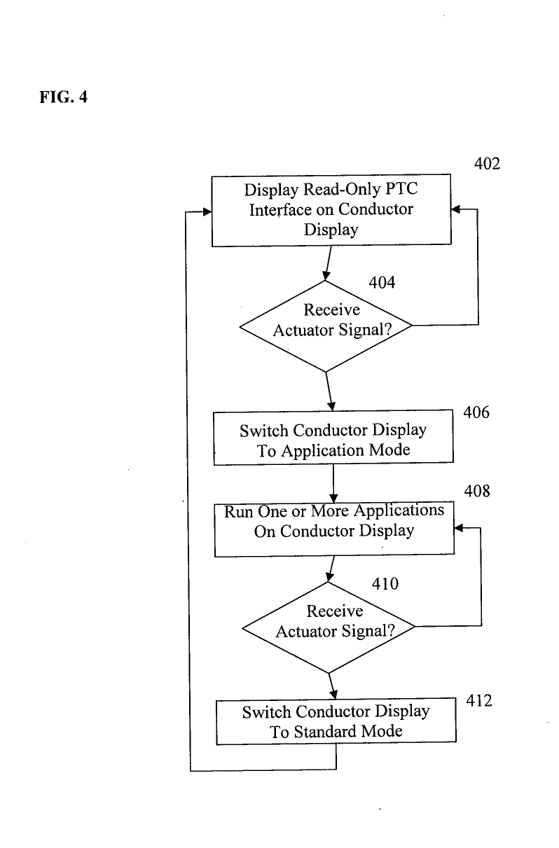

FIG. 4 illustrates a method of controlling the second, display 93 according to an embodiment of the present invention. The method of FIG. 4 begins with the second display 93 operating in the standard mode. As illustrated in FIG. 4, at step 402, the second, display 93, operating in the standard mode, displays a read-only display of the train control interface displayed on the first display 91. The train control interface displayed on the engineer display 91 is controlled by the vital controller 310 of the OBU and the same content is displayed on the second display 93 as on the first display 93. However, the second display 93 cannot be used to interact with this content.

At step 404, it is determined if a signal is received from the actuator 95. If a signal is not received from the actuator 95, the method returns to step 402 and the second display 93 continues to operate in the standard mode and display the read-only display of the train control interface. If a signal is received from the actuator 95, the method proceeds to step 406.

At step 406, the second display 93 is switched to the application mode. In an embodiment of the present invention, when the second display 93 is switched to the application mode, the second display 93 no longer displays the read-only train control interface. When the second display 93 is switched to the application mode, the conductor controls 97 (e.g., touch-screen controls) are activated.

At step 408, one or more applications are displayed on the second display 93 and controlled by the non-vital processor 320 of the OBU. A user (e.g., the conductor) can interact with the applications displayed on the second display 93 using the conductor controls 97. Various types of applications can be displayed on the second display 93 to allow the user to complete various tasks.

In one embodiment, an administrative application is displayed on the conductor display 93 to support the conductor in completing administrative tasks, such as completing paper forms. Such an administrative application allows the conductor to streamline such administrative tasks using a modern computerized interface. The administrative application replaces paper forms that the conductor is required to complete with digital forms that the conductor can complete using an interface on the conductor display 93 while the train is traveling. This avoids the unnecessary use of paper copies and saves time for the conductor, who would otherwise have to complete the paper forms after the train has finished traveling. The administrative application can communicate with a control center via a wireless network using a wireless transceiver that is part of the train equipment. This allows for direct synchronization of the information in the forms with back office data and dispatching information. Accordingly, the data in the forms is always consistent and directly synchronized with the source back office data. Furthermore, the administrative application can immediately send the forms to the control center via the wireless network, such that the data in the forms is readily available in the control center in real-time. Thus, this application reduces the overall administrative work required and increases the quality of the administrative work.

This and/or other applications displayed on the conductor display 93 may also act as a “Conductor Assistance System” by providing add-on functions, such as location-based services, location-based reminders, weather forecasts, and access to a database including manuals, “how-to” documents, and frequently asked questions (FAQ) relating to maintenance, repair, etc. The application can display notifications regarding when and where to connect and disconnect cars, display alert pop-ups and track bulletins, and provide task management and task notifications. Furthermore, the application can be used to monitor the status of the train and by displaying electronic train information and rail car status determined based on sensors on the rail cars. The application can be used for direct communication with the dispatcher or other people not on the train in place of phone or radio communications. For example, the application can provide confirmation form that can be submitted by the conductor to confirm instructions received from the dispatcher or a yardmaster. This application can also be used, to receive and display customer information regarding the placement or movement of cars.

In an advantageous embodiment, an application can be displayed on the conductor display 93 in the application mode to allow the conductor to submit switching requests. This would allow a conductor to set a switch directly utilizing the conductor display 93, instead of having to call a switch request in to a dispatcher and wait for the dispatcher to request a change to the switching alignment. This application connects (e.g., via the wireless transceiver) to the dispatching system so that the conductor can send a request to change the switch alignment directly to the dispatching system, without violating or compromising any safety features. Based on the same criteria as is the dispatcher has requested the change is switching alignment, the dispatching system will execute or decline the switching request. The dispatcher can monitor the switching requests made by the conductor using this application at his or her workstation and may override any requests submitted by the conductor. The switching request application automatically displays the section of the track where the train is currently located, making use of the location determination system integrated in the train control system, and also displays the current switch configuration. The application also provides an interface that allows the conductor to generate requests to change the current switching configuration, and transmits such switching requests directly to the dispatching system via a wireless network. The application may also notify the conductor when a request is executed, declined, or overridden by the dispatcher. In addition to switching requests, the application or a similar application can be used for other situations as well, such as the uncoupling of railcars on sidings.

The switching request application reduces the workload of all involved personnel. Instead of communicating a request to the dispatcher, the conductor can directly send the request to the dispatching system. This reduces the workload of the dispatcher. Further, this application saves time by eliminating any delays between requesting a change of switch alignments and execution. Thus, the train can proceed faster and unnecessary delays of following trains can be avoided. For example, in the case of uncoupling railcars on a siding, the switch has to be thrown twice while the train remains on the same section of track; which means the dispatcher does not necessarily need to be involved with the switch request.

It is to be understood that the above described applications are exemplary and other applications may also be controlled by the non-vital processor 320, other any other machine that utilizes the conductor display, to be displayed on the conductor display 93 when the conductor display 93 is operating in the application mode. Furthermore, it is to be understood that displaying such applications on the conductor display 93 is feasible only where the OBU is a vital system. In cases in which the OBU is not vital (i.e., does not perform at a low enough hazard rate to be considered failure free), the conductor display must display the train control interface and the conductor must monitor the engineer, so such applications cannot be displayed on the conductor display.

Returning to FIG. 4, at step 410, it is determined if a signal is received from the actuator 95. If a signal is not received from the actuator 95, the method returns to step 408 and the second display 93 continues to operate in the application mode and to display the applications controlled by the non-vital processor 320 of the OBU. If a signal is not received from the actuator 95, the method proceeds to step 412.

At step 412, the second display 93 is switched to the standard mode. When the second display 93 is switched to the standard mode, the non-vital processor 320 of the OBU controls the application that is displayed on the second display 93 to no longer be displayed on the second display 93, and the conductor controls 97 may be deactivated. The method then returns to step 402, and the second display 93 is controlled to display the read-only display of the train control interface.

Although various embodiments that incorporate the teachings of the present invention have been shown and described in detail herein, those skilled in the art can readily devise many other varied embodiments that, still incorporate these teachings.

What is claimed is:

1. A railway train control system, comprising:
a human-machine interface comprising:
a first display providing a train control interface for a first operator to control a set of functions of a train; and
a second display configured to display a read-only display of the train control interface in a standard mode and configured to display one or more applications for a second train operator in an application mode.

2. The railway train control system, further comprising:
a vital on-board unit comprising:
a vital controller configured to monitor the speed of the train and to intervene in controlling the speed of the train if the speed of the train exceeds local limits, and configured to control the train control interface; and
a non-vital processor configured to control the one or more applications displayed on the second display when the second display is in the application mode.

3. The rail train control system of claim 1, wherein the human machine interface further comprises:
an actuator for switching the second display between the standard mode and the application mode.

4. The rail train control system of claim 1, wherein the human, machine interface further comprises:
controls enabling the second user to interact with the one or more applications displayed on the second display when the second display is in the application mode.

5. The rail train control system of claim 4, wherein the controls are touch-screen controls.

6. The rail train control system of claim 4, wherein the controls are activated when the second display is in the application mode and deactivated when the second display is in the standard mode.

7. The rail train control system of claim 1, wherein the second display displays the one or more applications on a portion of the second display and the read-only display of the train control interface on another portion of the second display in the application mode.

8. The rail train control system of claim 1, wherein the second display displayed the one or more applications without displaying the read-only display of the train control interface in the application mode.

9. The rail train control system of claim 2, wherein the vital controller comprises first and second vital processors, wherein input data is independently processed by each of the first and second vital processors to generate output data, the output data generated by the first and second vital processors are compared, and the vital controller triggers emergency braking of the train if the output data generated by the first and second vital processors are not the same.

10. The rail train control system of claim 1, wherein the one or more applications comprise an administrative application that enables the second operator to fill out forms using the second display and automatically synchronizes information in the forms on the second display with back office data and dispatching information.

11. The rail train control system of claim 1, wherein the one or more applications comprise a switch requesting application that automatically displays a section of track where the train is currently located, enables the second operator to generate a request for a change in switch alignment, and transmits the request for the change in switch alignment to a dispatching system.

12. A human-machine interface of a train control system, comprising:
a multi-purpose display switchable between a standard mode and an application mode, the multi-purpose display configured to display a read-only display of a train control interface displayed on an another display in the standard mode and configured to display one or more applications for a user in the application mode; and
an actuator for switching the multi-purpose display between the standard mode and the application mode.

13. The human-machine interface of claim 12, further comprising:
controls enabling the user to interact with the one or more applications displayed on the multi-purpose display when the multi-purpose display is in the application mode.

14. The human-machine interface of claim 13, wherein the controls are touch-screen controls.

15. The human-machine interface of claim 13, wherein the controls are activated when the multi-purpose display is in the application mode and deactivated when the multi-purpose display is in the standard mode.

16. The human-machine interface of claim 12, wherein the multi-purpose display displays the one or more applications on a portion of the multi-purpose display and the read-only display of the train control interface on another portion of the multi-purpose display in the application mode.

17. The human-machine interface of claim 12, wherein the multi-purpose conductor display displays the one or more applications without displaying the read-only display of the train control interface in the application mode.

18. The human-machine interface of claim 12, further comprising:
the other display displaying the train control interface to enable another user to control one or more functions of a train.

19. An on board unit (OBU) of a railway train control system, the OBU comprising:
a vital controller configured to monitor the speed of the train, configured to intervene in controlling the speed of the train if the speed of the train exceeds local limits, configured to control a train control interface displayed on a first display, and configured to control a second display to display a read-only display of the train control interface when the second display is in a standard mode; and
a non-vital processor configured to control one or more applications to be displayed on the second display when the second display is in an application mode.

20. The OBU of claim 19, wherein the vital controller controls the second display to display the read-only display of the train control interface on a first, portion of the conductor display and the non-vital processor controls the one or more applications to be displayed on a second portion of the second display when the second display is in the application mode.

21. The OBU of claim 19, wherein the non-vital processor controls the one or more applications to be displayed on the second display without displaying the read-only display of the train control interface when, the second display is in the application mode.

22. A method of controlling a multi-purpose display in a railway train control system, the method comprising:
displaying, on the multi-purpose display, a read-only display of a train control interface displayed on another display in a standard mode of the multi-purpose display;
switching the multi-purpose display from the standard mode to an application mode; and
displaying one or more applications for user interaction on the multi-purpose display in the application mode.

23. The method of claim 22, further comprising:
receiving a signal from an actuator, wherein switching the multi-purpose display from the standard mode to the application is performed in response to receiving the signal from the actuator.

24. The method of claim 22, wherein switching the multi-purpose display from the standard mode to the application mode comprises:
activating controls that enable the user to interact with the multi-purpose display.

25. The method of claim 22, wherein displaying one or more applications for user interaction on the multi-purpose display in the application mode comprises:
controlling the one or more applications displayed on the multi-purpose display by a non-vital processor of a vital on-board unit (OBU) of the train control system.

26. The method of claim 22, wherein displaying one or more applications for user interaction on the multi-purpose display in the application mode comprises:
providing tillable forms to the user on the multi-purpose display; and
automatically synchronizing information in the tillable forms with back office data and dispatch information.

27. The method of claim 26, wherein displaying one or more applications for user interaction on the multi-purpose display in the application mode further comprises:
receiving input from the user via the multi-purpose display to fill the fillable forms; and
transmitting the filled, forms to a control center.

28. The method of claim 22, wherein displaying one or more applications for user interaction on the multi-purpose display in the application mode comprises:
providing, on the multi-purpose display, an interface to enable the user to input a request to change a switch alignment;
receiving the request to change the switch alignment input by the user via the multi-purpose display; and
transmitting the request to change the switch alignment to a dispatching system.

29. The method of claim 28, wherein providing, on the multi-purpose display, an interface to enable the user to input a request to change a switch alignment comprises:
automatically displaying a section of track where the train is currently located on the multi-purpose display; and
displaying a current switch alignment on the multi-purpose display.

30. The method of claim 28, wherein displaying one or more applications for user interaction on the multi-purpose display in the application mode further comprises:
displaying, on the multi-purpose display, one of an indication that the request to change the switch alignment has been executed, and indication that the request to change the switch alignment has been declined, and an indication that the request to change the switch alignment has been overruled by a dispatcher.
